(19) United States
(12) Patent Application Publication
(10) Pub. No.: US 2021/0074231 A1
(43) Pub. Date: Mar. 11, 2021

(54) PIXEL CIRCUIT AND DRIVING METHOD THEREOF, DISPLAY PANEL AND DISPLAY DEVICE

(71) Applicants: Ordos Yuansheng Optoelectronics Co., Ltd., Drdos, Inner Mongolia (CN); BOE TECHNOLOGY GROUP CO., LTD., Beijing (CN)

(72) Inventors: Jiguo WANG, Beijing (CN); Jun FAN, Beijing (CN)

(21) Appl. No.: 16/959,372

(22) PCT Filed: Dec. 23, 2019
(86) PCT No.: PCT/CN2019/127450

§ 371 Date: Jun. 30, 2020

(30) Foreign Application Priority Data
Jan. 21, 2019 (CN) 201910053954.1

(51) Int. Cl. G09G 3/36; G09G 3/20

(52) U.S. Cl. CPC G09G 3/3648; G09G 3/2007; G09G 2310/0202; G09G 2310/0251; G09G 2300/0842

(57) ABSTRACT

The present disclosure provides a pixel circuit and a driving method thereof, a display panel and a display device. The pixel circuit includes a switching circuit, an inverter, a potential maintaining circuit, and a charging circuit, the switching circuit writes data voltage signal into a first node under control of scanning signal, the first node is connection node of the switching circuit, the inverter, the potential maintaining circuit and the charging circuit; the inverter inverts potential of the first node and outputs inverted potential to a second node, the second node is connection node of the inverter and the charging circuit; the potential maintaining circuit maintains potential of the first node in response to the switching circuit being turned off; and the charging circuit controls display of a display unit according to potential of the first node and potential of the second node.

### CROSS REFERENCE TO RELATED APPLICATIONS

The present application claims priority from Chinese patent application No. 201910053954.1 filed on Jan. 21, 2019 to the Chinese Intellectual Property Office, the contents of which are incorporated herein by reference in their entirety.

### TECHNICAL FIELD

The present disclosure relates to the field of display technology, and particularly, relates to a pixel circuit and a driving method thereof, a display panel and a display device.

### BACKGROUND

As mobile displays become more miniaturized, mobile application products become more popular and widely used in daily life, and small size means that low capacity batteries, one-time-per-day charging or multiple-time-per-day charging become a bottleneck of the mobile application products. In order to reduce power consumption, MIP technology has been developed, in which memories are made in pixels to greatly reduce power consumption of a display device by reducing refresh frequency.

### SUMMARY

An aspect of the present disclosure provides a pixel circuit including a switching circuit, an inverter, a potential maintaining circuit, and a charging circuit, wherein the switching circuit is configured to write a data voltage signal into a first node under control of a scanning signal, the first node is a connection node of the switching circuit, the inverter, the potential maintaining circuit and the charging circuit; the inverter is configured to invert a potential of the first node and output the inverted potential to a second node, the second node is a connection node of the inverter and the charging circuit, the potential maintaining circuit is configured to maintain the potential of the first node in response to the switching circuit being turned off, and the charging circuit is configured to control display of a display unit according to the potential of the first node and a potential of the second node.

According to an embodiment of the present disclosure, the switching circuit includes a first switching transistor having a first switching characteristic, and a first electrode of the first switching transistor is coupled to a data line for transmitting the data voltage signal, a second electrode of the first switching transistor is coupled to the first node, and a control electrode of the first switching transistor is coupled to a scanning line for transmitting the scanning signal.

According to an embodiment of the present disclosure, an input terminal of the inverter is coupled to the first node, and an output terminal of the inverter is coupled to the second node.

According to an embodiment of the present disclosure, the inverter includes a second switching transistor having a second switching characteristic and a third switching transistor having the first switching characteristic, and a first electrode of the second switching transistor is coupled to a first power voltage terminal, a second electrode of the second switching transistor is coupled to a first electrode of the third switching transistor and the second node, a control electrode of the second switching transistor is coupled to a control electrode of the third switching transistor and the first node, and a second electrode of the third switching transistor is coupled to a second power voltage terminal.

According to an embodiment of the present disclosure, the potential maintaining circuit includes a first storage capacitor, and a first terminal of the first storage capacitor is coupled to the first node, and a second terminal of the first storage capacitor is coupled to the second power voltage terminal.

According to an embodiment of the present disclosure, the charging circuit includes a fourth switching transistor having the first switching characteristic and a fifth switching transistor having the first switching characteristic, wherein, a first electrode of the fourth switching transistor is coupled to a first signal line, a second electrode of the fourth switching transistor is coupled to the display unit and a second electrode of the fifth switching transistor, and a control electrode of the fourth switching transistor is coupled to the first node, a first electrode of the fifth switching transistor is coupled to a second signal line, a control electrode of the fifth switching transistor is coupled to the second node, and the charging circuit is configured to selectively output a first signal provided through the first signal line or a second signal provided through the second signal line.

According to an embodiment of the present disclosure, under control of the potential of the first node and the potential of the second node, the charging circuit is configured to perform one of operations of outputting the first signal to the display unit so that the display unit displays a first gray scale and outputting the second signal to the display unit so that the display unit displays a second gray scale.

Another aspect of the present disclosure provides a pixel circuit including a switching circuit, an inverter, a potential maintaining circuit, and a charging circuit, wherein, the switching circuit includes a first switching transistor having a first switching characteristic, a first electrode of the first switching transistor is coupled to a data line, a second electrode of the first switching transistor is coupled to a first node, and a control electrode of the first switching transistor is coupled to a scanning line, an input terminal of the inverter is coupled to the first node, and an output terminal of the inverter is coupled to a second node, the potential maintaining circuit includes a first storage capacitor, a first terminal of the first storage capacitor is coupled to the first node, and a second terminal of the first storage capacitor is coupled to a second power voltage terminal, and the charging circuit comprises a fourth switching transistor having the first switching characteristic and a fifth switching transistor having the first switching characteristic, a first electrode of the fourth switching transistor is coupled to a first signal line, a second electrode of the fourth switching transistor is coupled to a display unit and a second electrode of the fifth switching transistor, a control electrode of the fourth switching transistor is coupled to the first node, a first electrode of the fifth switching transistor is coupled to a second signal line, and a control electrode of the fifth switching transistor is coupled to the second node.

Another aspect of the present disclosure provides a driving method of the pixel circuit described above, the driving method includes a display phase, the display phase includes a first gray scale display sub-stage and a second gray scale display sub-stage, wherein in the first gray scale display sub-stage, an operation-level signal is provided through a scanning line as a scanning signal to turn on the switching circuit, and a data voltage signal at a high level is provided through a data line to make the charging circuit write a first signal into the display unit, so that the display unit displays a first gray scale; and in the second gray scale display sub-stage, the operation-level signal is provided through the scanning line as the scanning signal to turn on the switching circuit, and a data voltage signal at a low level is provided through the data line to make the charging circuit write a second signal into the display unit, so that the display unit displays a second gray scale.

Another aspect of the present disclosure provides a display panel including the pixel circuit described above.

Another aspect of the present disclosure provides a display device including the display panel described above.

### BRIEF DESCRIPTION OF THE DRAWINGS

FIG. 1 is a schematic structural diagram of a pixel circuit according to an embodiment of the present disclosure;

FIG. 2 is a schematic structural diagram of a pixel circuit according to an embodiment of the present disclosure;

FIG. 3 is a schematic structural diagram of a pixel circuit according to an embodiment of the present disclosure;

FIG. 4 is a timing diagram of an example signal according to an embodiment of the present disclosure.

### DETAILED DESCRIPTION

In order that those skilled in the art will better understand technical solutions of the present disclosure, the present disclosure will be further described in detail with reference to accompanying drawings and specific embodiments.

Transistors adopted in the embodiments of the present disclosure may be thin film transistors (TFTs), field effect transistors or other devices of the same characteristics, and since a source electrode and a drain electrode of an adopted transistor are interchangeable under certain conditions, the source electrode and the drain electrode of the transistor do not have difference in description of a connection relationship. In an embodiment of the present disclosure, in order to distinguish between the source electrode and the drain electrode of the transistor, one of the source electrode and the drain electrode is referred to as a first electrode, the other is referred to as a second electrode, and a gate electrode of the transistor is referred to as a control electrode. Further, the transistors can be classified into N-type transistors and P-type transistors according to their characteristics. When an N-type transistor is adopted, the first electrode is the source electrode of the N-type transistor, the second electrode is the drain electrode of the N-type transistor, and when a signal of low level is inputted into the gate electrode, the source electrode and the drain electrode are electrically connected. The situation is reversed for a P-type transistor. It can be seen that adopting the P-type transistor will be readily apparent to those skilled in the art without inventive effort and, and thus is within the scope of the embodiments of the present disclosure.

In an embodiment of the present disclosure, an example in which a first switching transistor, a third switching transistor, a fourth switching transistor, and a fifth switching transistor each having a first switching characteristic are N-type TFTs, and a second switching transistor having a second switching characteristic is a P-type TFT is taken for description. It is understood that each transistor having the first switching characteristic and the transistor having the second switching characteristic may be interchanged, which is also within the scope of the present embodiment.

In a case that the TFT is the N-type TFT, a corresponding operation-level signal is a high-level signal, an operation-level signal terminal is a high-level signal terminal, a non-operation-level signal is a low-level signal, and a non-operation-level signal terminal is a low-level signal terminal.

In the following embodiments, an example in which a pixel circuit is applied to a liquid crystal display device with a vertical electric field, a first gray scale is L255 gray scale (white) and a second gray scale is L0 gray scale (black) is taken for description. It should be understood that the pixel circuit can also be applied to a display device with a vertical electric field, with the first gray scale being the L0 gray scale (black) and the second gray scale being the L255 gray scale (white). The case in which the second grayscale frame has the L255 grayscale (white) is taken as an example for description. It should be understood that the first gray scale and the second gray scale frames are only frames with two gray scales, and therefore, are not limited to a black frame and a white frame.

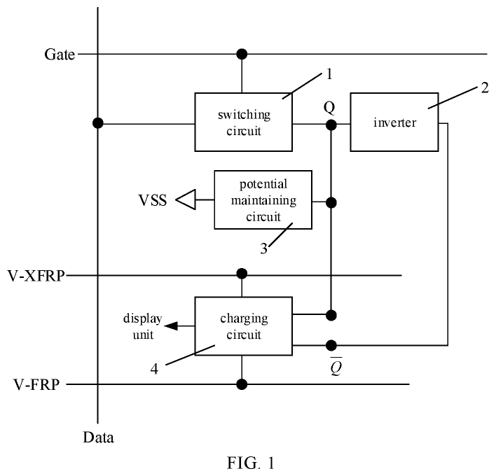

As shown in FIG. 1, an embodiment of the present disclosure provides a pixel circuit including a switching circuit 1, an inverter 2, a potential maintaining circuit 3, and a charging circuit 4. The switching circuit 1 is configured to write a data voltage signal into node Q under a control of a scanning signal. The node Q is a connection node of the switching circuit 1, the inverter 2, the potential maintaining circuit 3, and the charging circuit 4. The inverter 2 is configured to invert a potential of the node Q and output the inverted potential to node Q̅. The node Q̅ is a connection node between the inverter 2 and the charging circuit 4. The potential maintaining circuit 3 is configured to maintain the potential of the node Q when the switching circuit 1 is turned off. The charging circuit 4 is configured to control display of a display unit based on the potential of the node Q and the potential of the node Q̅.

In the pixel circuit according to the present embodiment, since the potential maintaining circuit 3 can maintain the potential of the node Q when the switching circuit 1 is turned off, normal display of the display unit can be prevented from being affected.

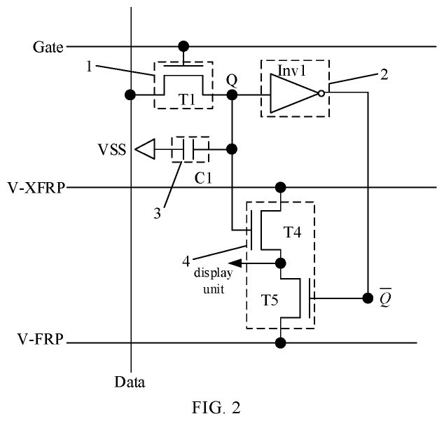

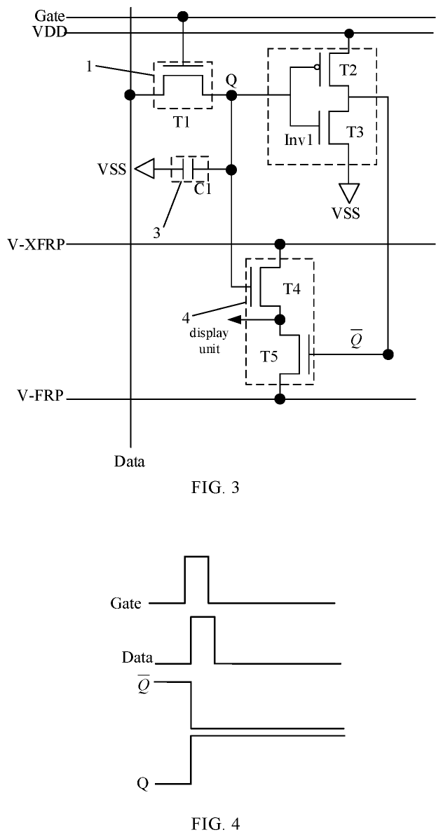

Each functional block of the pixel unit of the present embodiment will be specifically described below with reference to FIGS. 2 and 3.

The switching circuit 1 includes a first switching transistor T1 having a first switching characteristic, that is, the first switching transistor T1 is an N-type TFT.

According to an embodiment of the present disclosure, a first electrode of the first switching transistor T1 is coupled to a data line Data, a second electrode of the first switching transistor T1 is coupled to the node Q, and a control electrode of the first switching transistor T1 is coupled to a scanning line Gate. When an operation-level signal, that is, a high-level signal, is applied to the scanning line Gate, the first switching transistor T1 is turned on, and a data voltage signal applied to the data line Data is written to the node Q. When the data voltage signal is a high-level signal, the potential of the node Q is at a high level, and at this time, a signal output by the inverter 2 is at a low level, that is, the potential of the node Q̅ is at a low level. When the data voltage signal is a low-level signal, the potential of the node Q is at a low level, and at this time, the signal output by the inverter 2 is at a high level, that is, the potential of the node Q̅ is at a high level.

The inverter 2 may be an inverter Inv1. The inverter Inv1 has an input terminal coupled to the node Q and an output terminal coupled to the node Q̅.

According to an embodiment of the present disclosure, the inverter Inv1 may include a second switching transistor T2 having a second switching characteristic and a third switching transistor T3 having the first switching characteristic. That is, the inverter Inv1 includes the third switching transistor T3 of the N-type and the second switching transistor T2 of a P-type. A first electrode of the second switching transistor T2 is coupled to a first power voltage terminal VDD, and a second electrode of the second switching transistor T2 is coupled to a first electrode of the third switching transistor T3 and the node Q̅, a control electrode of the second switching transistor T2 is coupled to a control electrode of the third switching transistor T3 and the node Q, and a second electrode of the third switching transistor T3 is coupled to a second power voltage terminal VSS.

The potential maintaining circuit 3 may include a first storage capacitor C1. A first terminal of the first storage capacitor C1 is coupled to the node Q, and a second terminal of the first storage capacitor C1 is coupled to the second power voltage terminal VSS.

According to an embodiment of the present disclosure, when a high-level signal is applied to the scanning line Gate, the switching circuit 1 is turned on, and the first storage capacitor C1 is charged by the data voltage signal provided through the data line Data. When a low-level signal is applied to the scanning line Gate, the switching circuit 1 is turned off, and at this time, the first storage capacitor C1 is discharged to maintain the potential of the node Q.

According to an embodiment of the present disclosure, under the control of the potential of the node Q and the potential of the node Q̅, the charging circuit 4 outputs a first signal to the display unit to display a first gray scale or outputs a second signal to the display unit to display a second gray scale.

For example, when the potential of the node Q is at a high level, the charging circuit 4 outputs the first signal to the display unit to display the first gray scale, and when the potential of the node Q is at a low level, the charging circuit 4 outputs the second signal to the display unit to display the second gray scale.

The charging circuit 4 includes a fourth switching transistor T4 and a fifth switching transistor T5 each having the first switching characteristic. That is, the fourth switching transistor T4 and the fifth switching transistor T5 in the charging circuit 4 are both N-type TFTs. A first electrode of the fourth switching transistor T4 is coupled to a first signal line V-XFRP, a second electrode of the fourth switching transistor T4 is coupled to the display unit and a second electrode of the fifth switching transistor T5, and a control electrode of the fourth switching transistor T4 is coupled to the node Q. A first electrode of the fifth switching transistor T5 is coupled to a second signal line V-FRP, the second electrode of the fifth switching transistor T5 is coupled to the display unit and the second electrode of the fourth switching transistor T4, and a control electrode of the fifth switching transistor T5 is coupled to the node Q. The charging circuit 4 selectively outputs either the first signal supplied via the first signal line V-XFRP or the second signal supplied via the second signal line V-FRP.

When the node Q is at a high level and the node Q̅ is at a low level, the fourth switching transistor T4 is turned on, and the first signal is written to the display unit through the first signal line V-XFRP, so that the display unit displays the first gray scale according to the first signal. For example, the first signal charges a pixel electrode in the display unit and makes an absolute value of a voltage difference between the pixel electrode and a common electrode in the display unit low, so that liquid crystal molecules disposed between the pixel electrode and the common electrode in the display unit do not rotate reversely, and the display unit displays the L255 gray scale.

When the node Q is at a low level and the node Q̅ is at a high level, the fifth switching transistor T5 is turned on, and the second signal is written to the display unit through the second signal line V-FRP, so that the display unit displays the second gray scale according to the second signal. For example, the second signal charges the pixel electrode in the display unit and makes the absolute value of the voltage difference between the pixel electrode and the common electrode in the display unit high, so that the liquid crystal molecules disposed between the pixel electrode and the common electrode of the display unit rotate reversely, and the display unit displays the L0 gray scale.

Since the pixel circuit includes the potential maintaining circuit 3 which includes the first storage capacitor C1, the potential of the node Q can be maintained by the first storage capacitor C1 when the switching circuit 1 is turned off, so as to ensure normal display of the display unit. Moreover, the pixel circuit according to the embodiments of the present disclosure includes only three TFTs, one inverter Inv1, and one storage capacitor, so that the pixel circuit has a simple structure which contributes to high-resolution design for a display device. In addition, the pixel circuit according to the embodiments of the present disclosure does not include a phase-locked loop, and when the first switching transistor T1 is turned on, the first storage capacitor C1 needs to be charged only, and the pixel circuit can avoid a problem of competition and risk caused by the phase-locked loop.

Referring to FIGS. 2 to 4, there is also provided a driving method for the pixel circuit according to an embodiment of the present disclosure. The driving method includes a display stage, and the display stage includes an L255 gray scale display sub-stage and/or an L0 gray scale display sub-stage.

In the L255 gray scale display sub-stage, an operation-level signal is provided as a scanning signal to turn on the switching circuit 1, and a data voltage signal at a high level is provided through the data line to make the charging circuit 4 write a first signal into the display unit, so that the display unit displays the L255 gray scale.

In the L0 gray scale display sub-stage, the operation-level signal is provided through the scanning line as the scanning signal to turn on the switching circuit 1, and the data voltage signal at a low level is provided through the data line to make the charging circuit 4 write a second signal into the display unit, so that the display unit displays the L0 gray scale.

An embodiment of the present disclosure provides a pixel circuit. As shown in FIGS. 2 and 3, the pixel circuit includes a switching circuit 1, an inverter 2, a potential maintaining circuit 3, and a charging circuit 4. The switching circuit 1 includes a first switching transistor T1. The first switching transistor T1 is an N-type TFT, A first electrode of the first switching transistor T1 is coupled to a data line Data, a second electrode of the first switching transistor T1 is coupled to a node Q, and a control electrode of the first switching transistor T1 is coupled to a scanning line Gate. The inverter 2 includes an inverter Inv1. An input terminal of the inverter Inv1 is coupled to the node Q, and an output terminal of the inverter Inv1 is coupled to a node Q̅. The potential maintaining circuit 3 includes a first storage capacitor C1. A first terminal of the first storage capacitor C1 is coupled to the node Q, and a second terminal of the first storage capacitor C1 is coupled to a second power voltage terminal VSS. The charging circuit 4 includes a fourth switching transistor T4 and a fifth switching transistor T5, both of which are N-type TFTs. A first electrode of the fourth switching transistor T4 is coupled to a first signal line, a second electrode of the fourth switching transistor T4 is coupled to a display unit and a second electrode of the fifth switching transistor T5, and a control electrode of the fourth switching transistor T4 is coupled to the node Q. A first electrode of the fifth switching transistor T5 is coupled to a second signal line, the second electrode of the fifth switching transistor T5 is coupled to the display unit and the second electrode of the fourth switching transistor T4, and a control electrode of the fifth switching transistor T5 is coupled to the node Q̅.

Since the potential maintaining circuit 3 included in the pixel circuit according to the present embodiment includes a first storage capacitor C1, a potential of the node Q can be maintained by the first storage capacitor C1 when the switching circuit 1 is turned off, so as to ensure normal display of the display unit. Moreover, the pixel circuit according to the embodiment includes only three thin film transistors, one inverter Inv1, and one storage capacitor, so that the pixel circuit has a simple structure which contributes to high-resolution design for a display device.

With reference to FIGS. 2 and 4, an embodiment of the present disclosure further provides a driving method for the pixel circuit. The driving method includes a display stage, and the display phase includes an L255 gray scale display sub-stage and/or an L0 gray scale display sub-stage.

For example, in the L255 gray scale display sub-stage, an operation-level signal is written through the scanning line Gate, the first switching transistor T1 is turned on, and a data voltage signal written through the data line Data is a high-level signal; at this time, a potential of the node Q is at a high level, and a potential of the Q̅ node after the inverter Inv1 is at a low level, thus the fourth switching transistor T4 is turned on and the fifth switching transistor T5 is turned off; at this time, a pixel electrode in the display unit is charged by a first signal written through a first signal line, an absolute value of a difference between the pixel voltage and a common voltage is low, and liquid crystal molecules disposed between the pixel electrode and the common electrode of the display unit do not rotate reversely, and at this time, the display unit displays an L255 gray scale.

At the L0 grayscale display sub-stage, the operation-level signal is written through the scanning line Gate, the first switching transistor T1 is turned on, and a data voltage signal written through the data line Data is a low-level signal; at this time, the potential of the node Q is at a low level, and the potential of the node Q̅ after the inverter Inv1 is at a high level, thus the fourth switching transistor T4 is turned off and the fifth switching transistor T5 is turned on; at this time, the pixel electrode in the display unit is charged by a second signal written through a second signal line, the absolute value of the difference between the pixel voltage and the common voltage is high, and the liquid crystal molecules disposed between the pixel electrode and the common electrode of the display unit rotate reversely, and at this time, the display unit displays an L0 gray scale.

An embodiment of the present disclosure provides a display panel including the pixel circuit as described above and a display device including the display panel.

The display device may be a liquid crystal display device or an electroluminescent display device, such as a liquid crystal panel, an electronic paper, an OLED panel, a mobile phone, a tablet computer, a television, a display, a notebook computer, a digital photo frame, a navigator, a wearable device, and any other product or component with a display function.

It will be understood that the above embodiments are merely exemplary embodiments employed to illustrate the principles of the present disclosure, but the present disclosure is not limited thereto. It will be apparent to those skilled in the art that various changes and modifications may be made therein without departing from the spirit and scope of the present disclosure, and these changes and modifications are to be considered within the scope of the present disclosure.

1. A pixel circuit, comprising: a switching circuit, an inverter, a potential maintaining circuit, and a charging circuit, wherein
the switching circuit is configured to write a data voltage signal into a first node under control of a scanning signal, the first node being a connection node of the switching circuit, the inverter, the potential maintaining circuit and the charging circuit,
the inverter is configured to invert a potential of the first node and output an inverted potential to a second node, the second node being a connection node of the inverter and the charging circuit,
the potential maintaining circuit is configured to maintain the potential of the first node in response to the switching circuit being turned off, and
the charging circuit is configured to control display of a display unit according to the potential of the first node and a potential of the second node.

2. The pixel circuit of claim 1, wherein the switching circuit comprises a first switching transistor having a first switching characteristic, and
a first electrode of the first switching transistor is coupled to a data line for transmitting the data voltage signal, a second electrode of the first switching transistor is coupled to the first node, and a control electrode of the first switching transistor is coupled to a scanning line for transmitting the scanning signal.

3. The pixel circuit of claim 1, wherein an input terminal of the inverter is coupled to the first node, and an output terminal of the inverter is coupled to the second node.

4. The pixel circuit of claim 3, wherein the inverter comprises: a second switching transistor having a second switching characteristic and a third switching transistor having a first switching characteristic, and
a first electrode of the second switching transistor is coupled to a first power voltage terminal, a second electrode of the second switching transistor is coupled to a first electrode of the third switching transistor and the second node, a control electrode of the second switching transistor is coupled to a control electrode of the third switching transistor and the first node, and a second electrode of the third switching transistor is coupled to a second power voltage terminal.

5. The pixel circuit of claim 1, wherein the potential maintaining circuit comprises a first storage capacitor, and
a first terminal of the first storage capacitor is coupled to the first node, and a second terminal of the first storage capacitor is coupled to a second power voltage terminal.

6. The pixel circuit of claim 1, wherein the charging circuit comprises a fourth switching transistor having a first switching characteristic and a fifth switching transistor having a first switching characteristic,
a first electrode of the fourth switching transistor is coupled to a first signal line, a second electrode of the fourth switching transistor is coupled to the display unit and a second electrode of the fifth switching transistor, and a control electrode of the fourth switching transistor is coupled to the first node,
a first electrode of the fifth switching transistor is coupled to a second signal line, and a control electrode of the fifth switching transistor is coupled to the second node, and
the charging circuit is configured to selectively output a first signal provided through the first signal line or a second signal provided through the second signal line.

7. The pixel circuit of claim 6, wherein under control of the potential of the first node and the potential of the second node, the charging circuit is configured to perform one of operations of:
outputting the first signal to the display unit so that the display unit displays a first gray scale; and
outputting the second signal to the display unit so that the display unit displays a second gray scale.

8. A pixel circuit, comprising: a switching circuit, an inverter, a potential maintaining circuit, and a charging circuit, wherein
the switching circuit comprises a first switching transistor having a first switching characteristic, a first electrode of the first switching transistor is coupled to a data line, a second electrode of the first switching transistor is coupled to a first node, and a control electrode of the first switching transistor is coupled to a scanning line,
an input terminal of the inverter is coupled to the first node, and an output terminal of the inverter is coupled to a second node,
the potential maintaining circuit comprises a first storage capacitor, a first terminal of the first storage capacitor is coupled to the first node, and a second terminal of the first storage capacitor is coupled to a second power voltage terminal, and
the charging circuit comprises a fourth switching transistor having the first switching characteristic and a fifth switching transistor having the first switching characteristic, a first electrode of the fourth switching transistor is coupled to a first signal line, a second electrode of the fourth switching transistor is coupled to a display unit and a second electrode of the fifth switching transistor, a control electrode of the fourth switching transistor is coupled to the first node, a first electrode of the fifth switching transistor is coupled to a second signal line, and a control electrode of the fifth switching transistor is coupled to the second node.

9. A driving method of a pixel circuit, the pixel circuit being the pixel circuit of claim 1, the driving method comprising: a display phase, the display phase comprising a first gray scale display sub-stage and a second gray scale display sub-stage, wherein
in the first gray scale display sub-stage, an operation-level signal is provided through a scanning line as a scanning signal to turn on the switching circuit, and a data voltage signal at a high level is provided through a data line to make the charging circuit write a first signal into the display unit, so that the display unit displays a first gray scale; and
in the second gray scale display sub-stage, the operation-level signal is provided through the scanning line as the scanning signal to turn on the switching circuit, and a data voltage signal at a low level is provided through the data line to make the charging circuit write a second signal into the display unit, so that the display unit displays a second gray scale.

10. A display panel, comprising the pixel circuit of claim 1.

11. A display device, comprising the display panel of claim 10.

12. The pixel circuit of claim 8, wherein the inverter comprises: a second switching transistor having a second switching characteristic and a third switching transistor having a first switching characteristic, and
a first electrode of the second switching transistor is coupled to a first power voltage terminal, a second electrode of the second switching transistor is coupled to a first electrode of the third switching transistor and the second node, a control electrode of the second switching transistor is coupled to a control electrode of the third switching transistor and the first node, and a second electrode of the third switching transistor is coupled to a second power voltage terminal.

13. A driving method of a pixel circuit, the pixel circuit being the pixel circuit of claim 8, the driving method comprising: a display phase, the display phase comprising a first gray scale display sub-stage and a second gray scale display sub-stage, wherein
in the first gray scale display sub-stage, an operation-level signal is provided through a scanning line as a scanning signal to turn on the switching circuit, and a data voltage signal at a high level is provided through a data line to make the charging circuit write a first signal into the display unit, so that the display unit displays a first gray scale; and
in the second gray scale display sub-stage, the operation-level signal is provided through the scanning line as the scanning signal to turn on the switching circuit, and a data voltage signal at a low level is provided through the data line to make the charging circuit write a second signal into the display unit, so that the display unit displays a second gray scale.

14. A display panel, comprising the pixel circuit of claim 8.

15. A display device, comprising the display panel of claim 13.
